(19) United States
(12) Patent Application Publication
(10) Pub. No.: US 2005/0117904 A1
(43) Pub. Date: Jun. 2, 2005

(54) Integrated optical transmitter, receiver for free space optical communication and network system and application apparatus thereof

(76) Inventors: Youngwan Choi, Seoul (KR); Kyuman Cho, Seoul (KR)

Correspondence Address: FLESHNER & KIM, LLP, P.O. BOX 221200, CHANTILLY, VA, 20153, US

(21) Appl. No.: 10/381,816

(22) PCT Filed: Aug. 1, 2001
(86) PCT No.: PCT/KR01/01310

(51) Int. Cl. H04J 14/02

(52) U.S. Cl. 398/79

(57) ABSTRACT

The present invention relates to the optical transmitter, receiver and application apparatus thereof for OWLL (Optical WireLess Link) which transmits and receives the optical signals through the free space and FSON (Free Space Optical Network) system using OWLL. Photonic devices such as laser diode and photo detector and integrated circuits for driving the photonic devices are formed directly into a single chip and the chip is assembled with optical instrument which is manufactured as a standardized optical module. Then, the optical transmitter, receiver and application apparatus thereof becomes small, light, cost-effective, multi-functional and reliable.

### FIELD OF THE ART

The present invention relates to a transmitter, receiver and application apparatuses thereof enabling an optical wireless link (“OWLL”) using communication method in which optical signals are transmitted/received through the free space, i.e., the air, and a free space optical network (“FSON”) system using the OWLL.

### BACKGROUND OF THE INVENTION

The 21th century information communication society requires a social environment in which the subscribers can exchange the large amount of information at high speed, and such high speed communication becomes possible due to the improvements of the wireless communication technique of high frequency band and high speed optical communication technique using optical fibers. The study of optical communication which started in 1970s has progressed recent ten and some years to minimize the transmission loss to extend the transmission distance and to transmit a large amount of information at high speed, and now the optical communication system is in the stage of practical use, that is, the band width of the core optical communication network is over 100 Gbps, and it may reach some Tbps by 2000s. However, the technique providing the information at over tens of Mbps speed for the final user or subscriber is not developed so much.

Roles of optical communication technique, which secure the high speed, parallelism, and large capacity, are very important to establish very high speed broadband integrated services communication network. The conventional wireless communication system, which transmits data at tens of kbps speed in PCS system of 2 GHz, is not enough to provide wireless multimedia service. In this regard, studies about IMT-2000 having maximum data transmission rate of 2 Mbps, which is called as the third generation wireless communication, are in progress, and now it is in the stage of practical user. However, the next generation multimedia system for very high rate data transmission such as HDTV requires tens to hundreds Mbps rate data transmission for the subscribers, therefore, the IMT-2000 cannot be a final solution.

The next generation multimedia is a system and service which make various information such as text, data, audio, graphic, photo, animation, image, etc. to produce, collect, transmit, and process integrally, and the multimedia industry means the industrial field related to those activities. Recently, the multimedia information industry goes in the direction of digitalization, bi-directionization, asynchronization, and integrallization of image, sound, etc. in the content, form, and exchange method due to the development of the technologies in computer and communication fields. The effect of the technology development to the industrial structure is evolutional. For the most important obstacle to the present multimedia service, the performance of the communication network having insufficient capacity is pointed out, and the role of locomotive to progressive reproduction of the next generation multimedia is given to providing the communication network of very high speed and large capacity for individual subscribers economically.

It is considered that the only network technology which able to provide the very high speed and large capacity information for individual subscribers is the fiber-to-the-home (“FTTH”), however, in case of the FTTH, the installation is difficult, and the cost of installation is large because additional cost is required to lay the optical fiber underground as well as the communication device. Moreover, it requires additional steps of aligning between the optical fiber and laser diode (“LD”) or photo detector (“PD”) for the optical transmitting/receiving module. The present invention pursues very economical and easily installable optical transmitting/receiving module which enabling FSON which can solve the problems of the FTTH instead of the wireless communication network using coaxial cables and microwave (“MW”) transmitting/receiving device such as high frequency oscillator, modulator, etc. to connect the base station (“BS”) and the central base station (“CBS”) such as mobile service switching center.

Until now, the FSON is used as the back-up system for the existing wire network utilizing the advantages that the service can be provided instantly because the installation is easy and fast and that the communication protection is guaranteed physically, or most efforts are concentrated on development of high power transceiver focusing point-to-point connection considering quick installation, therefore, it is not used so practically.

Therefore, the present invention suggests economical transmitting/receiving modules for FSON suitable to provide the very high speed and large capacity information for a plurality of users or subscribers stably using OWLL and FSON system using OWLL different from the existing simple point-to-point type.

### SUMMARY OF THE INVENTION

The new OWLL and FSON system leaded to resolve the problems and limits of the above described convention technology has differences to the conventional wire/wireless communication network in that they can provide the complex multimedia communication service such as high-speed internet, point-to-point and point-to-multiple point data, audio, and image transmission with very high speed, large capacity, stability, and efficiency preparing the next generation multimedia era.

The OWLL and FSON system in which basic blocks are set according to the transmission distance and transmission rate and such blocks are combined in various way to provide very high speed and large capacity information without being affected by the position and distance of the subscriber is the communication system of completely new concept for very high speed and large capacity communication system. The OWLL and FSON system should be robust to the turbulence of the air, temperature gradient, snow, rain, fog, etc. and able to change the intensity and direction of the optical output, bit-rate, etc. adaptively according to the surrounding environments. In addition, it should be constituted as a system able to monitor, control, and operate the transmitting/receiving status integrally.

The necessities for OWLL and FSON system are the economical transmitter, receiver, and various application apparatuses thereof enabling the OWLL and FSON system. Therefore, the object of the present invention is to provide the transmitter, receiver, and various application apparatuses thereof for OWLL and FSON.

Another object of the present invention is to provide the transmitter, receiver, and various application apparatuses thereof for OWLL, which are small, light, cheap, stable, and reliable.

To achieve the above objects, the present invention provides transmitting/receiving apparatuses for providing OWLL and FSON information communication service in which light source(s) such as laser diode, photo-electric device(s) for optical transmission and reception such as photo detector, and related circuit(s) are formed on one printed circuit board, and the printed circuit board and the optics modules are manufactured as standardized modules to be easily assembled with each other.

To achieve the above objects, the present invention provides transmitting/receiving apparatuses for providing OWLL and FSON information communication service in which light source(s) such as laser diode, photo-electric device(s) for optical transmission and reception such as photo detector, and related circuit(s) are formed on one printed circuit board, and the printed circuit board and the optics modules are manufactured as standardized modules to be easily assembled with each other.

That is, a transmitter for free space optical communication according to the present invention comprises: a semiconductor substrate; a light source formed on the substrate; a photo detector formed on the substrate for detecting the light from the light source; a current driver and automatic output controller circuit integrally formed on the substrate for driving the light source using the input signals from the outside and controlling the output power of the light source using the signals from the photo detector; a frame, where the substrate is fixed, having a plurality of pins for electrical connection to the outside; and an optics module formed to be assembled with the frame for receiving the light from the light source and transmitting the received light to the external free space.

Here, the light source is preferably a laser diode or a light emitting diode. The optics module comprises: a lens; and a lens holder being able to adjust the focal length of the lens, and an aspheric lens or a Fresnel lens can be used for the lens.

In addition, the transmitter of the present invention further includes a first screw unit formed to be integrated or assembled with the frame; and a second screw unit formed to be integrated or assembled with the optics module to make the frame and the optics module be assembled using the first and second screw units. The light from the transmitter is eye-safe.

A receiver for free space optical communication according to the present invention comprises: a semiconductor substrate having a first and a second faces being opposite to each other; a photo detector formed on the first face of the substrate; an optical receiver circuit integrally formed on the first face of the substrate for transforming and outputting the signals received from the photo detector; a frame, where the substrate is fixed, having a plurality of pins for electrical connection to the outside; and an optics module formed to be assembled with the frame for receiving the light from the external free space and transmitting the received light to the photo detector.

Here, the optical receiver circuit comprises a terminal for monitoring the magnitude of input signal at the outside of the optical receiver circuit, and it is preferable that the receiver further includes a display unit connected to the terminal via at least one of the plurality of pins of the frame for displaying the magnitude of input signal to the outside of the receiver or the magnitude of input signal can be transferred to the base station at the outside of the receiver.

Also, the receiver of the present invention has a first screw unit formed to be integrated or assembled with the frame; and a second screw unit formed to be integrated or assembled with the optics module to make it possible for the frame and the optics module to be assembled using the first and second screw units.

On the other hand, the optics module is arranged in a row with the optical receiver circuit and the photo detector or parallel to the second face on or above the second face side. In case of the latter, the frame has an aperture exposing a part of the second face opposite to the part of the first face where the light source is formed, the optics module is a lens formed on the second face of the substrate, and the aperture exposes a part where the lens is formed. The lens can be formed by etching or coating.

A transceiver for free space optical communication according to the present invention comprises: a semiconductor substrate; a light source formed on the substrate; a first photo detector formed on the substrate for detecting the light from the light source; a current driver and automatic output controller circuit integrally formed on the substrate for driving the light source using the input signals from the outside and controlling the output power of the light source using the signals from the first photo detector; a second photo detector formed on the substrate; an optical receiver circuit integrally formed on the substrate for transforming and outputting the signals received from the second photo detector; a frame, where the substrate is fixed, having a plurality of pins for electrical connection to the outside; a transmitting optics module formed to be assembled with the frame for receiving the light from the light source and transmitting the received light to the external free space; and a receiving optics module formed to be assembled with the frame for receiving the light from the external free space and transmitting the received light to the second photo detector.

Here, the transceiver further includes a first screw unit formed to be integrated or assembled with the frame and adjacent with the part of the substrate where the light source is formed; a second screw unit formed to be integrated or assembled with the frame and adjacent with the part of the substrate where the second photo detector is formed; a third screw unit formed to be integrated or assembled with the transmitting optics module; and a fourth screw unit formed to be integrated or assembled with the receiving optics module, and it is preferable that the frame and the transmitting optics module are assembled using the first and third screw units and the frame and the receiving optics module are assembled using the second and fourth screw units.

The transmitting optics module and the receiving optics module can face to the same side, and the transmitting optics module and the receiving optics module have the same configuration or different configurations from each other.

Here, it is possible to fix a first and a second frames on one printed circuit board after fixing a first and a second substrates on the first and second frames after forming the light source, first photo detector, current driver and automatic output controller circuit on the first substrate and forming the second photo detector and optical receiver circuit for optical communication on the second substrate.

The transceiver of the present invention may provide a connection with an optical fiber link. That is, a transceiver according to another embodiment of the present invention comprises: a semiconductor substrate; a first light source formed on the substrate; a first photo detector formed on the substrate for detecting the light from the first light source; a first current driver and automatic output controller circuit integrally formed on the substrate for driving the first light source using the input signals from the outside and controlling the output power of the first light source using the signals from the first photo detector; a first optical receiver circuit integrally formed on the substrate and connected to the first current driver and automatic output controller circuit for providing the first current driver and automatic output controller circuit with input signals; a second photo detector connected to the first optical receiver circuit for providing the first optical receiver circuit with input signal; a first optical fiber adaptor connected to the second photo detector for connecting the second photo detector to an optical fiber; a third photo detector formed on the substrate; a second optical receiver circuit integrally formed on the substrate for transforming and outputting the signals received from the third photo detector; a second current driver and automatic output controller circuit integrally formed on the substrate for receiving signals from the second optical receiver circuit; a second light source connected to the second current driver and automatic output controller circuit and driven by the second current driver and automatic output controller circuit; a second optical fiber adaptor connected to the second light source for connecting the second light source to an optical fiber; a frame, where the substrate is fixed, having a plurality of pins for electrical connection to the outside; a transmitting optics module formed to be assembled with the frame for receiving the light from the first light source and transmitting the received light to the external free space; and a receiving optics module formed to be assembled with the frame for receiving the light from the external free space and transmitting the received light to the third photo detector.

Here, the second photo detector and the second light source may be packaged in TO-cans, respectively, or formed directly on the substrate.

Moreover, the transceiver of the present invention provides a connection to the Ethernet using a media converter, and a transceiver of another embodiment for this purpose comprises: a semiconductor substrate; a light source formed on the substrate; a first photo detector formed on the substrate for detecting the light from the light source; a current driver and automatic output controller circuit integrally, formed on the substrate for driving the light source using the input signals from the outside and controlling the output power of the light source using the signals from the first photo detector; a second photo detector formed on the substrate; an optical receiver circuit integrally formed on the substrate for transforming and outputting the signals received from the second photo detector; a frame, where the substrate is fixed, having a plurality of pins for electrical connection to the outside; a transmitting optics module formed to be assembled with the frame for receiving the light from the first light source and transmitting the received light to the external free space; a receiving optics module formed to be assembled with the frame for receiving the light from the external free space and transmitting the received light to the second photo detector; and a media converter circuit, integrally formed on the substrate and connected to the current driver and automatic output controller circuit and the optical receiver circuit, for transforming the signals transmitted from the optical receiver circuit to Ethernet signals and for transforming Ethernet signals received from the outside to the current driver and automatic output controller circuit and transmitting it, and having UTP (unshielded twisted-pair) port for transmitting and receiving Ethernet signals to and from the outside.

A transponder for free space optical communication according to the present invention comprises a semiconductor substrate; a light source formed on the substrate; a first photo detector formed on the substrate for detecting the light from the tight source; a current driver and automatic output controller circuit integrally formed on the substrate and connected to the light source for driving the light source using the input signals from the outside and controlling the output power of the light source using the signal from the first photo detector; a multiplexer circuit integrally formed on the substrate and connected to the current driver and automatic output controller circuit for multiplexing the input signals from the outside and outputting the multiplexed signals to the current driver and automatic output controller circuit; a second photo detector formed on the substrate; an optical receiver circuit integrally formed on the substrate for transforming and outputting the signals received from the second photo detector; a demultiplexer circuit integrally formed on the substrate and connected to the optical receiver circuit for receiving signals from the optical receiver circuit and outputting demultiplexed signals; a frame, where the substrate is fixed, having a plurality of pins for electrical connection to the outside; a transmitting optics module formed to be assembled with the frame for receiving the light from the first light source and transmitting the received light to the external free space; and a receiving optics module formed to be assembled with the frame for receiving the light from the external free space and transmitting the received light to the second photo detector.

A transponder for free space optical communication according to another embodiment of the present invention comprises: a first semiconductor substrate; a first photo detector formed on the first substrate; an optical receiver circuit integrally formed on the first substrate for transforming and outputting the signals received from the first photo detector; a demultiplexer circuit, integrally formed on the first substrate, having an input port connected to the optical receiver circuit for receiving signals from the optical receiver circuit, a drop port for distributing a part of demultiplexed signals, and an output port for outputting the rest of the demultiplexed signals; a first frame, where the first substrate is fixed, having a plurality of pins for electrical connection to the outside; a second semiconductor substrate; a light source formed on the second substrate; a second photo detector formed on the substrate for detecting the light from the light source; a current driver and automatic output controller circuit integrally formed on the second substrate and connected to the light source for driving the light source using the input signals from the outside and controlling the output power of the light source using the signals received from the second photo detector; a multiplexer circuit, integrally formed on the second substrate, having an input port for receiving signals from the output port of the demultiplexer, an add port for receiving additional signals from the outside, and an output port for outputting multiplexed signal to the current driver and automatic output controller circuit; a second frame, where the second substrate is fixed, having a plurality of pins for electrical connection for the outside; a printed circuit board where the first and second frames are fixed at a predetermined interval; a transmitting optics module formed to be assembled with the printed circuit board for receiving the light from the first light source and transmitting the received light to the external free space; and a receiving optics module formed to be assembled with the printed circuit board for receiving the light from the external free space and transmitting the received light to the second photo detector.

### BRIEF DESCRIPTION OF THE DRAWINGS

FIG. 1 is a schematic diagram showing a transmitter for free space optical communication according to an embodiment of the present invention.

FIG. 2 is a block diagram showing an example of a current driver and automatic output controller circuit used in the transmitter shown in FIG. 1.

FIGS. 3 and 4 are schematic diagrams showing transmitters for free space optical communication according to another embodiments of the present invention.

FIG. 5 is a schematic diagram showing a receiver for free space optical communication according to an embodiment of the present invention.

FIG. 6 is a block diagram showing an example of an optical receiver circuit used in the receiver shown in FIG. 5.

FIGS. 7 and 8 are schematic diagrams showing transmitters for free space optical communication according to another embodiments of the present invention.

FIG. 9 shows a transceiver for free space optical communication according to an embodiment of the present invention.

FIG. 10 shows a transceiver for free space optical communication according to another embodiment of the present invention.

FIG. 11 shows a transceiver for free space optical communication accessible via optical fiber link according to an embodiment of the present invention:

FIG. 12 shows a transceiver for free space optical communication accessible via optical fiber link according to another embodiment of the present invention.

FIG. 13 is a schematic diagram showing a transceiver for free space optical communication able to connect to the Ethernet according to another embodiment of the present invention.

FIG. 14 shows an example of a transponder for free space optical communication according to the present invention.

FIGS. 15 and 16 are schematic diagrams showing the transmitting and receiving parts of a transponder for free space optical communication whose transmitting and receiving parts are separated according to an embodiment of the present invention, respectively.

FIG. 17 is a layout diagram showing a receiver for free space optical communication according to another embodiment of the present invention.

FIGS. 18 through 20 are sectional diagrams showing receivers for free space optical communication according to another embodiments of the present invention.

### BEST MODE FOR CARRYING OUT THE INVENTION

Now, preferred embodiments of the present invention will be described in detail with reference to accompanying drawings.

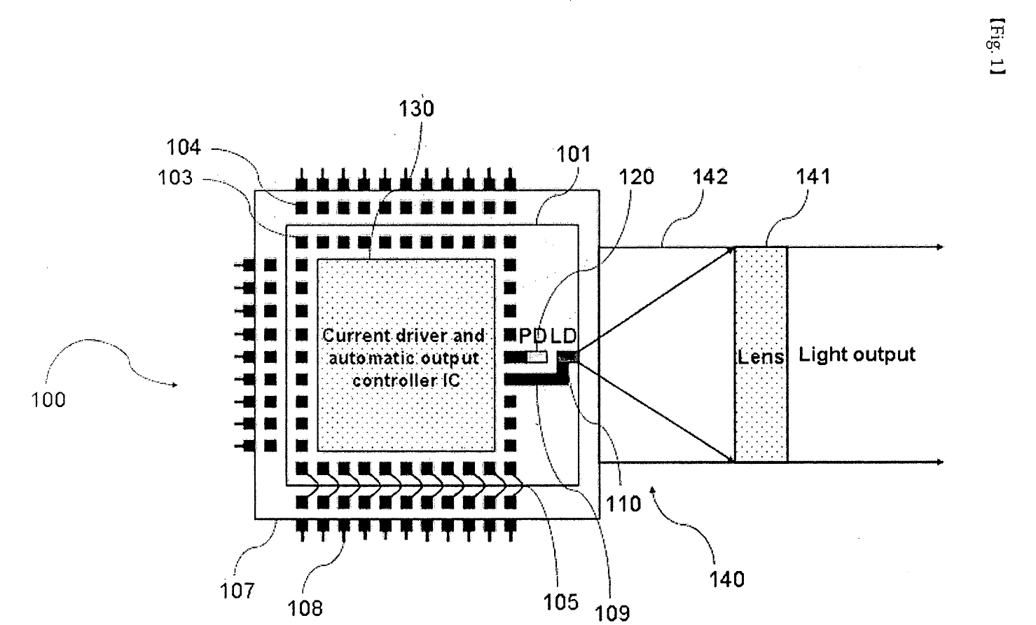

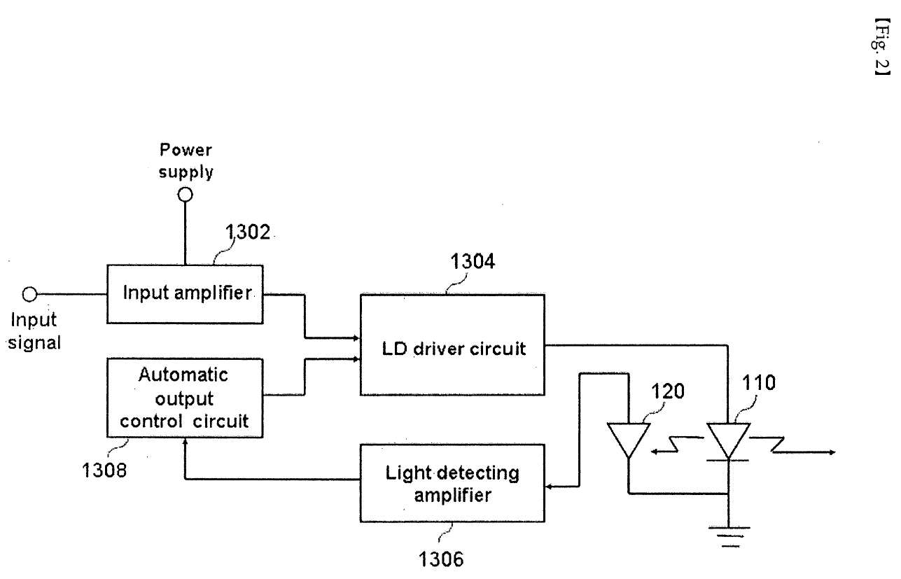

First, a structure of a transmitter for free space optical communication will be described. FIG. 1 is a schematic diagram showing a transmitter 100 for free space optical communication according to an embodiment of the present invention, and FIG. 2 is a block diagram showing an example of a current driver and automatic output controller circuit used in the transmitter shown in FIG. 1.

As shown in FIG. 1, a current driver and automatic output controller integrated circuit (“IC”) 130 is formed on a semiconductor substrate 101 made of silicon (“Si”), etc. in a transmitter 100. The current driver and automatic output controller IC 130 can be formed in various ways, and an example thereof is shown in FIG. 2. That is, it includes an input amplifier 1302 receiving an input signal from the outside and amplifying the signal and a LD driver circuit 1304 driving the LID 110, the light source, using the signal amplified through the input amplifier 1302, and the signal detected through the PD 120 is amplified by the light detecting amplifier 1306, transmitted to the automatic output control circuit 1308, and used to control the LD driver circuit 1304. In addition, the current driver and automatic output controller IC 130 is manufactured according to known IC manufacturing process.

On the substrate 101 on which the current driver and automatic output controller IC 130 is formed, a laser diode (“LD”) 110, which is a light source to transmit a light carrying an free space optical communication signal to the free space outside of the transmitter 100 is formed. A light emitting diode (“LED”) can be used as the light source as well as LD. For LDs, various kinds of LDs such as Febry-Perot LD, distributed feedback LD (“DFB-LD”), vertical cavity surface emitting laser (“VCSEL”), etc. can be used. The light from the LD 110 is collimated through an optics module 140 and transmitted to the free space. It is related to the transmission distance of the transmitter which kind of light sources is used. Transmitters can be classified for very short distance (less than 100 m), short distance (50-300 m), middle distance (150-500 m), and long distance (500-2000 m), and, for example, a VCSEL having a nominal wavelength of 0.85*10-6 m is preferably used for the very short distance transmitter as the light source. In addition, the nominal wavelength of the light from the LD can be 1.3*10-6 m or 1.55*10-6 m if the transmitter according to the present invention is used for the middle distance of less than 500 m or short distance of less than 300 m free space optical communication. It is preferable that the light from the light source satisfies the safety standard for human body including the eyes.

Moreover, a photo detector (“PD”) 120 is formed on the PCB 101 adjacent to the LD 110 having a little bit of space between them to detect the light from the LD 110. For PD 120, various kinds of devices such as MSM (metal-semiconductor-metal) PD, PIN (inversely biased P—N junction) PD, APD (avalanche photodiode), etc. can be used. The PD 120 detects the light from the LD 110 and uses it as a signal to control the output of the LD 110.

The current driver and automatic output controller IC 130 formed on the substrate 101 has a plurality of bonding pads 103 to provide the connection with the circuit, and the LD 110 and PD 120 are connected to the parts providing connections to corresponding connecting parts in the current driver and automatic output controller IC 130 among bonding pads 103. That is, the LD 110 is connected to the LD driver circuit 1304 of FIG. 2, and the PD 120 is connected to the light detecting amplifier 1306 in FIG. 2. Since the LD 110 is placed on the part connected to an optics module, a separate connecting part 109 can be formed to connect to the current driver and automatic output controller IC 130.

The process of forming the current driver and automatic output controller IC 130 on the substrate 101 follows a general semiconductor manufacturing process, and the PD 120 can be formed together in the circuit manufacturing process if needed. In case of LD 110, an LD device formed separately is attached on the substrate 101. Manufactured substrate 101 is fixed on an IC frame 107, and bonding pads 103 provided for the IC 130 are wire bonded with bonding pads 104 of the ID frame 107 to be connected to the outside via pins 108 of the IC frame 107.

On the other hand, the optics module 140 is constituted of a lens 141 and a lens holder 142, and it is fixed on the IC frame 107 where the substrate 101 on which the light source 110, PD 120, and IC 130 are formed is fixed. The lens 141 may be an aspheric lens or a Fresnel lens. Since a Fresnel lens can be manufactured easily by using an injection method, etc., it has an advantage to reduce the manufacturing cost of the transmitter. At this tinge, it is preferable that the lenses are standardized for transmission distances to manufacture the transmitter. In addition, the lens holder 142 is formed to adjust the position of the lens 141 before and behind in the optics module 140 to adjust the focal distance according to the use of the transmitter.

The light from the light source 110 is collimated by the lens 141 to a proper extent to be received by a receiver, and the nominal beam divergence of the light from the transmitter is 1*10-3 radian.

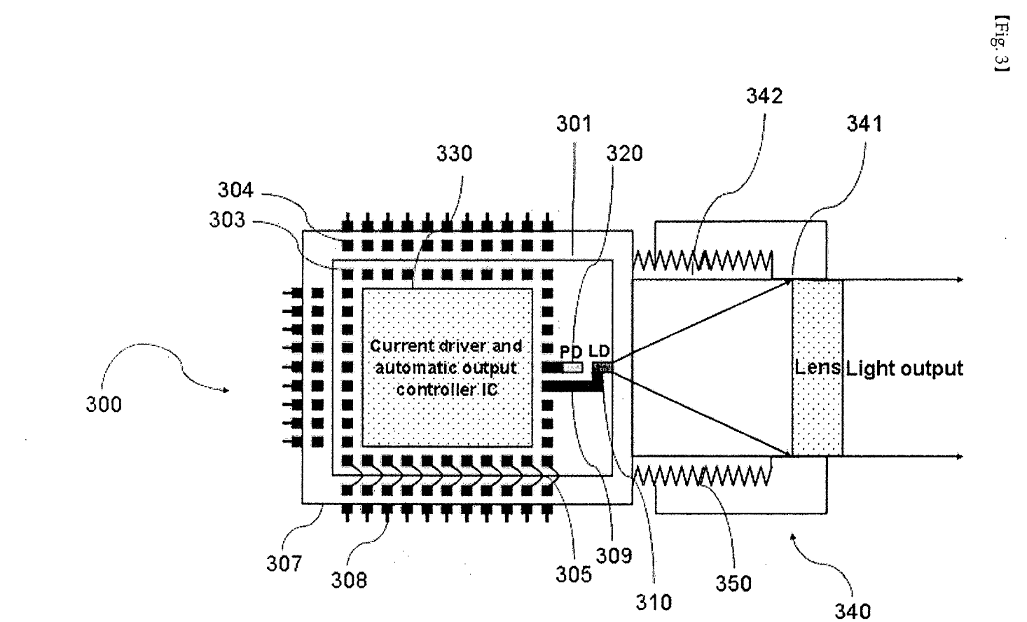

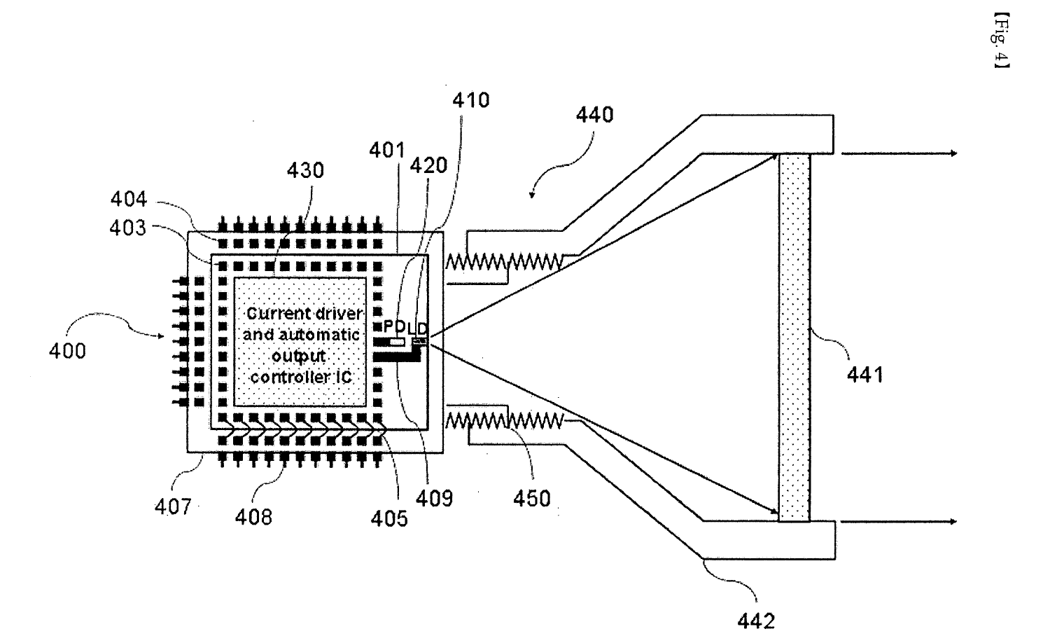

On the other hand, the optics module 140 and IC freme 107 are formed as standardized blocks to be assembled with each other easily, and they are fixed together after assembling. FIGS. 3 and 4 show examples of the transmitter which have screw units to assemble the optics module and IC frame. As shown in FIG. 3 or 4, screw units 350 in FIG. 3 and 450 in FIG. 4 are formed on both sides of the optics modules 340 in FIG. 3 and 440 in FIG. 4 and the IC frames 307 in FIG. 3 and 407 in FIG. 4 to assemble two parts by turning the screws. The screw units can be formed integrally with the IC frame or optics module, or they can be formed to be assembled with the IC frame or optics module. In FIGS. 3 and 4, the assembled forms by turning the screws are shown. In FIGS. 3 and 4, other components have similar structures as described with reference to FIG. 1, the similar components are indicated as similar symbols. To form screw units for the optics module and IC frame, it is possible to form frame surrounding the optics module or IC frame and form screw units therein.

When the screw units are formed, it is preferable that the screw units of the standardized gauge are formed in optics module having lenses of various sizes and IC frames including ICs which are also standardized for each of the transmission distances are formed, two parts of which can be assembled according to the needs. Then, it is possible to optionally mount lenses of small or large diameter according to the needs such as the transmission distance, reliability, etc. for the same IC frame. That is, according to the present invention, it is very easy to manufacture a transmitter of proper standard because the IC frame and optics module can be easily assembled by a method of forming screw units, etc.

In addition, it is preferable that an output window transparent to the wavelength of the light source is provided outside of the optics module to install the transmitter outdoors. A protective cover or heater to confront the change of humidity or temperature can also be provided.

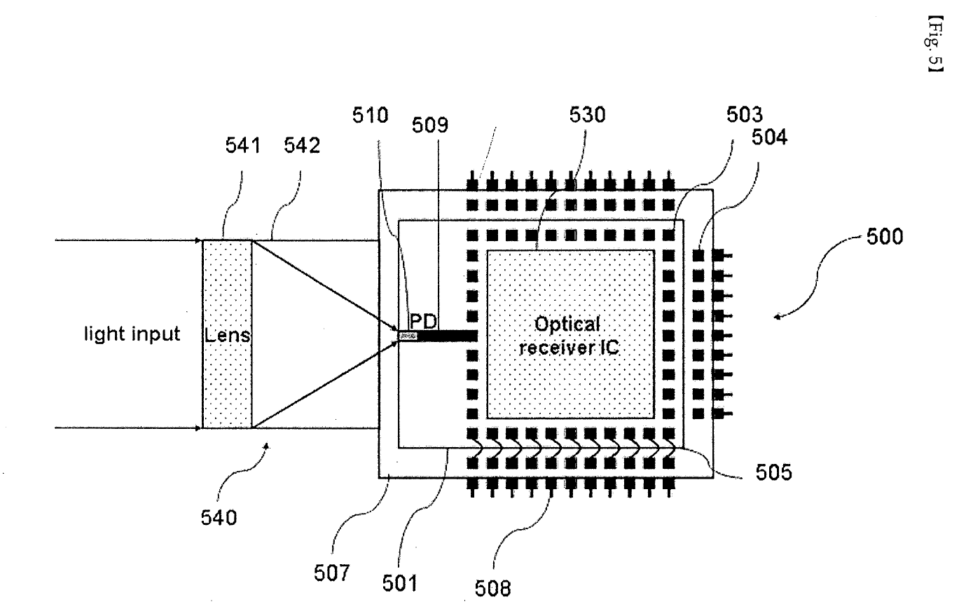

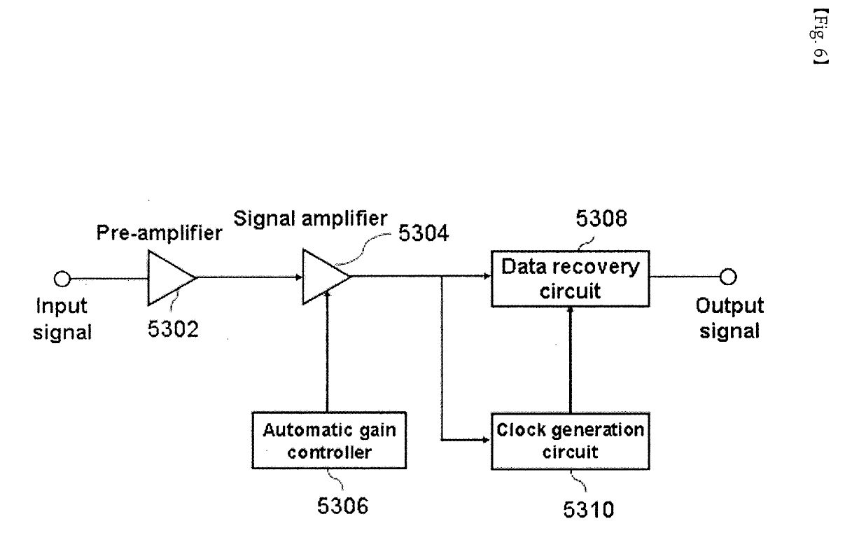

Now, a structure of a receiver free space optical communication will be described. FIG. 5 is a schematic diagram showing a receiver for free space optical communication according to an embodiment of the present invention, and FIG. 6 is a block diagram showing an example of an optical receiver circuit used in the receiver shown in FIG. 5.

In the receiver 500, a optical receiver IC 530 having an example structure shown in FIG. 6 is formed on a substrate 510 made of Si, etc. The optical receiver IC 530 can be constituted of a pre-amplifier (“TIA” which is a trans-impedance amplifier) 5302 to amplify the signal from a PD 510, a signal amplifier 5304 to amplify the signal transmitted from the pre-amplifier 5302, an automatic gain controller 5306 to control the gain of the received signal, a data recovery circuit 5308 to recover the data from the received signal, a clock generation circuit 5310 to extract the clock from the received signal and transmit it to the data recovery circuit 5308, etc. The optical receiver IC 530 is also manufactured according to known IC manufacturing process.

On the substrate 501, the PD 510 to detect a light received from the free space outside of the receiver is formed. For PD 510, various kinds of devices such as MSM PD, PIN PD, APD, etc. can be used as used in the transmitter 100. A connecting part 509 to connect the PD 510 to the optical receiver IC 530 is also formed.

The process of forming the PD 510 and the optical receiver IC 530 on the substrate 501 follows a general semiconductor manufacturing process, and the PD 510 and the optical receiver IC 530 can be formed together in the same manufacturing process. Completed substrate 501 is fixed on an IC frame 507, and bonding pads 503 provided for the IC 530 are wire bonded with bonding pads 504 of the ID frame 507 for the optical receiver IC 530 to be connected to the outside via pins 508 of the IC frame 507.

The light received from the outside is collected via an optics module 540 and transmitted to the PD 510. The optics module 540 is constituted of a lens 541 and a lens holder 542 similar to the transmitter 100. For lens 521, an aspheric lens or Fresnel lens can be used as in the transmitter 100. The efficiency of the beam collection can be maximized if a Fresnel lens 5411 is used. In addition, since the Fresnel lens can be easily manufactured by using a very economical way such as an injection method, etc., it is more advantageous to secure economical efficiency of transmitter and/or receiver for FSON than any other lenses. Moreover, since the Fresnel lens has a large numerical aperture, which makes the acceptance angle large, it is possible to receive the light signal easily and effectively.

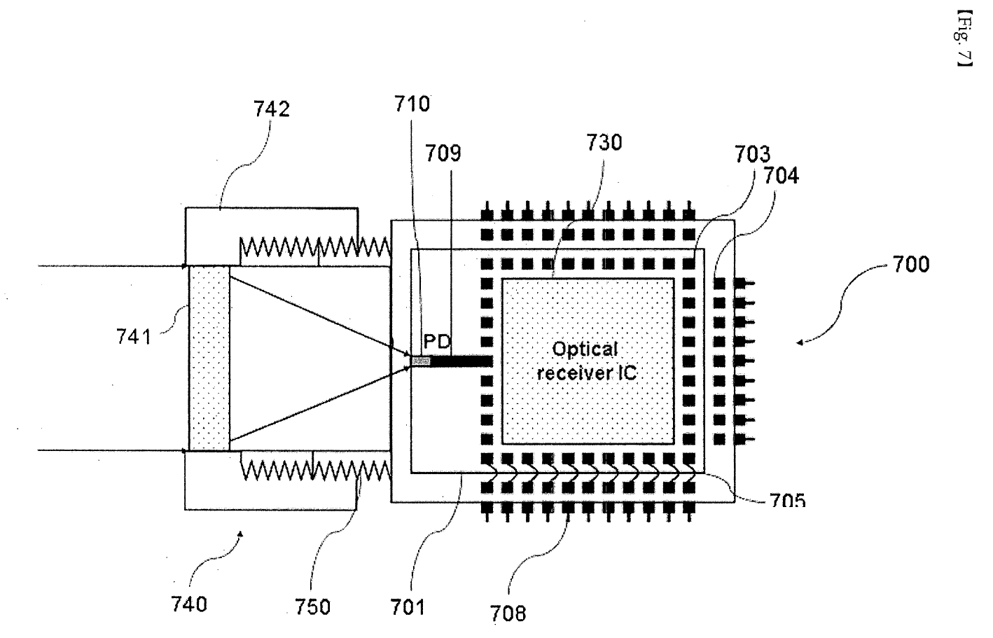

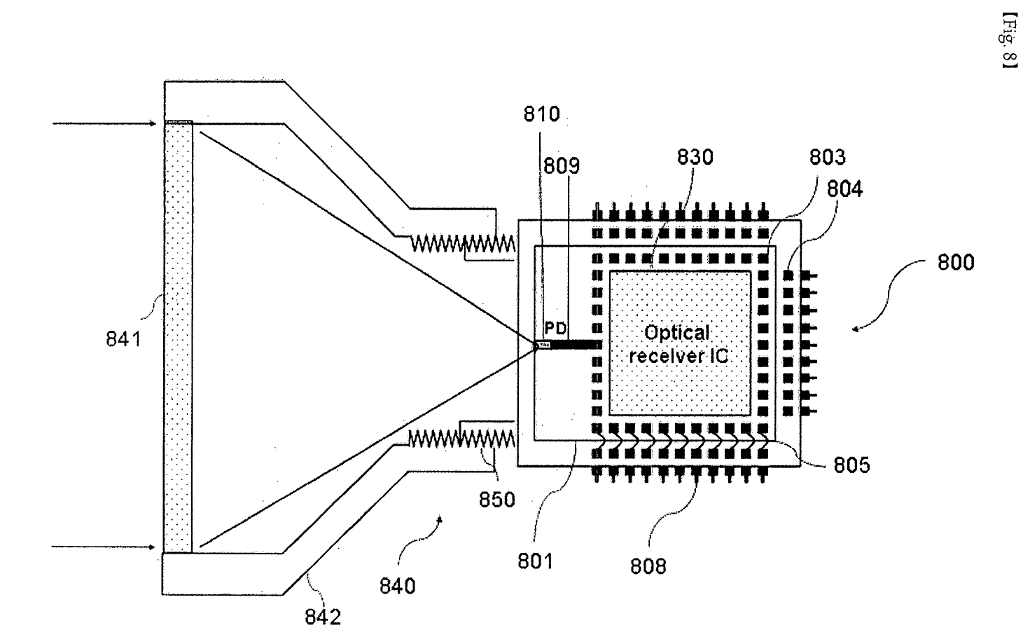

It is preferable to make the optics module and IC frame of the receiver as standardized blocks to be assembled with each other easily as in the transmitter. FIGS. 7 and 8 show examples of the receiver which have screw units to assemble the optics module and IC frame. As shown in FIG. 7 or 8, screw units 750 in FIG. 7 and 850 in FIG. 8 are formed on both sides of the optics modules 740 in FIG. 7 and 840 in FIG. 8 and the IC frames 701 in FIG. 7 and 801 in FIG. 8 to assemble two parts by turning the screws. As in the transmitter, the screw units can be formed integrally with the IC frame or optics module, or they can be formed to be assembled with the IC frame or optics module. Screw units may be formed to have a standard gauge able to assemble the lens of a proper size according to needs. In FIGS. 7 and 8, the assembled form by turning the screws is shown. In FIGS. 7 and 8, other components have similar structures as described with reference to FIG. 5, the similar components are indicated as similar symbols. To form screw units for the optics module and IC frame, it is possible to form frames surrounding the optics module or IC frame and form screw units therein.

The fact that the transmitter and receiver should constantly have reliability is a very important function of the free space optical communication system. In case of OWLL, there is a possibility for the intensity of a signal to be degraded if the alignment between the transmitter and the receiver becomes wrong different from the optical fiber communication link. Therefore, the alignment between the transmitter and the receiver should be monitored constantly if it maintains good condition or not. For this purpose, a monitoring terminal 539 to monitor the intensity of the received signal constantly can be provided according to the embodiment of the present invention as shown in FIG. 5. In addition, it is possible to display the intensity of the signal received to the receiver by connecting the monitoring terminal 330 to a display device (not shown). As the display device, an LED of a visible ray can be used. Addition to the displaying the intensity externally, it is possible to report the extent of degradation of the signal obtained on the optical receiver circuit to the central base station which manages and administrates the whole FSON system.

The conventional transceiver for fiber optical communication using optical fiber needs a precise packaging which spends a long time to align and pig-tail between the LD and the fiber or between the PD and the fiber to an extent of minuteness of some μm. Therefore, the cost of manufacturing the conventional transceiver is very high. On the other hand, the transceiver for OWLL and FSON as suggested in the present invention has a advantage to be manufactured very economically. That is, since the transceiver for OWLL and FSON as suggested in the present invention is very economical, the FSON system can be more economical than FTTH (fiber-to-the-home) system.

In case of the receiver, it is preferable that it accepts only the light in which the transmitter outputs selectively. The output light of the transmitter is the light having nominal wavelength of 0.85*10-6 m, 1.3*10-6 m, 1.55*10-6 m, etc. as described above. For this purpose, it is preferable to provide an input window transparent only to the light in which the transmitter outputs and able to shield the normal light in front of the optics module of the receiver. To install the receiver outdoors, it may also need to provide a protective cover or heater.

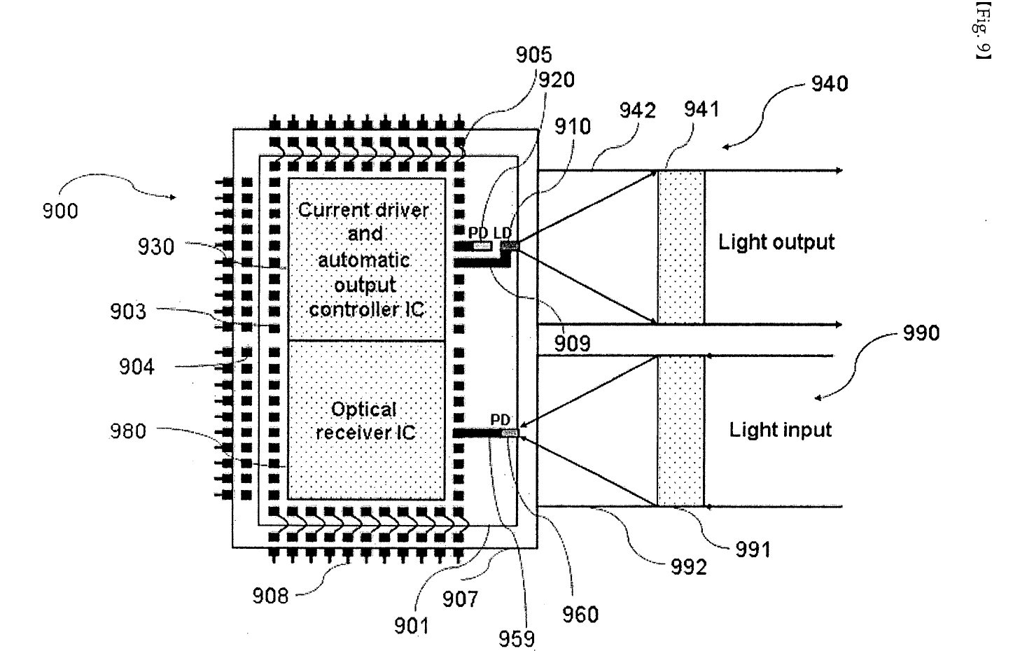

FIG. 9 shows an all-in-one transceiver (“TRX”) for OWLL and FSON system in which a transmitter and a receiver are formed as one module. Since the OWLL and FSON system is basically a bi-directional communication system, the transmitter and the receiver tend to be used together other than used separately. The transmitter in FIG. 9 is that the transmitter and the receiver shown in FIGS. 1 and 5, respectively, are formed integrally for this purpose.

As shown in FIG. 9, a transmitting/receiving IC 930 is formed integrally on a semiconductor substrate 901, and an LD 910 and a PD 920 for light transmitting module and a PD 960 for light receiving module are formed together on the substrate 901. An IC frame on which the semiconductor substrate 901 is fixed is assembled with a transmitting optics module 940 and a receiving optics module 990. The other structures are similar to those of the transmitter 100 and the receiver 500. If the transceiver is formed like this, the light transceiver becomes very small. Therefore, this structure is useful when the size of the optics module can be very small.

However, transceivers often face to each other when an OWLL is constituted. In this case, the light signal may input to the light source of the transmitting optics module of the transceiver as well as the receiving optics module, and sometimes, large optics modules of a few to several tens cm scale are needed. Therefore, a prescribed space should be maintained between the transmitting part and the receiving part of the transceiver, and it is advantageous to constitute the circuits of transmitting and receiving part separately.

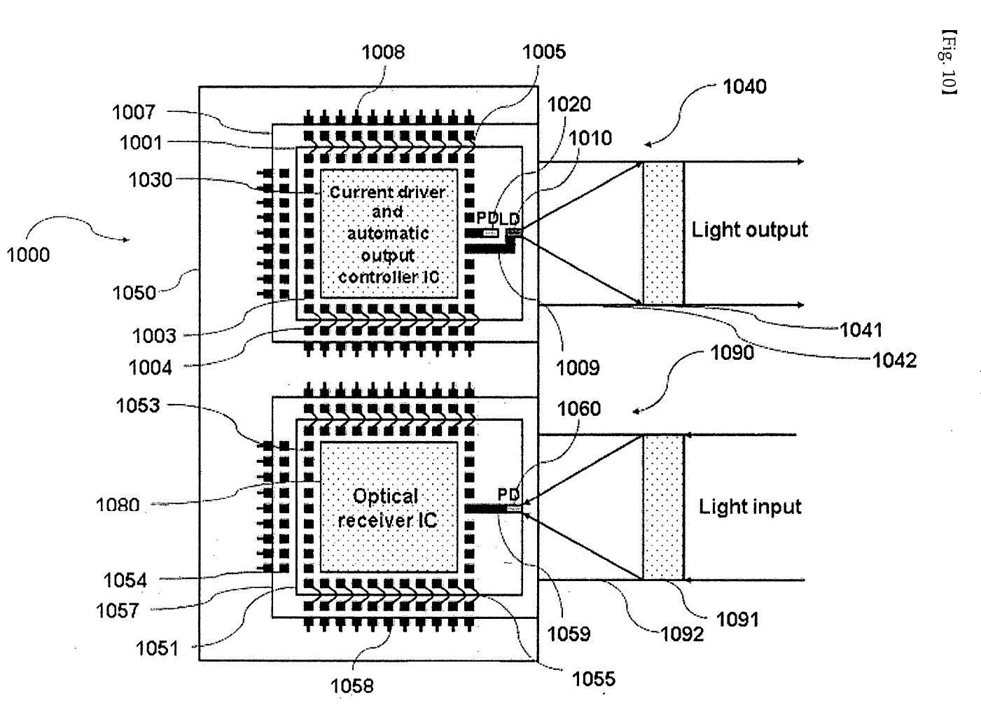

In FIG. 10, an example of the transceiver in which the circuits of the transmitting and receiving parts are separated is shown. As shown in FIG. 10, a current driver and automatic output controller IC 1030 for transmitting part and an optical receiver IC 1080 for receiving part are formed on different semiconductor substrates 1001 and 1051. An LD 1010 and a PD 1020 are formed together on the substrate 1001 for transmitting part and connected to the current driver and automatic output controller IC 1030, and a PD 1060 is formed on the substrate 1051 for receiving part and connected to the optical receiver IC 1080. Each substrate 1001 or 1051 is fixed on an IC frame 1007 or 1057, and those IC frames are placed on another substrate 1050 having an appropriate interval between them. The interval between transmitting and receiving parts can be determined properly by the size of the optics module forming the transceiver, etc. A transmitting optics module 1040 and a receiving optics module 1090 are assembled to the light source1010 of transmitting part and the PD 1060 of receiving part, respectively.

In the transceivers 900 and 1000 shown in FIGS. 9 and 10, the transmitting optics modules 940 and 1040 and receiving optics modules 990 and 1090 can be manufactured as standardized modules and assembled with IC frames or substrates as in the transmitter 100 and the receiver 500 described above, and assembling method can also be same as used in the transmitter 100 or receiver 500. In addition, The transceivers 900 and 1000 shown in FIGS. 9 and 10 can have all characteristics of the transmitter 100 and receiver 500 described above For the transmitting and receiving optics modules 940 and 1040, it is possible to use the same standard or different standards. Moreover, in the transceivers shown in FIGS. 9 and 10, the transmitting optics module 940 and 1040 and receiving optics modules 990 and 1090 are installed in the same direction, however, they can be installed in different directions. For this purpose, the positions of the circuits and optical devices formed on the substrate can be properly adjusted.

On the other hand, OWLL and FSON system of the present invention can be effectively used by combining with the existing optical communication system using optical fibers. For this purpose, the transceiver of the present invention may include the constitution of the transceiver for optical fiber communication to provide the optical fiber link.

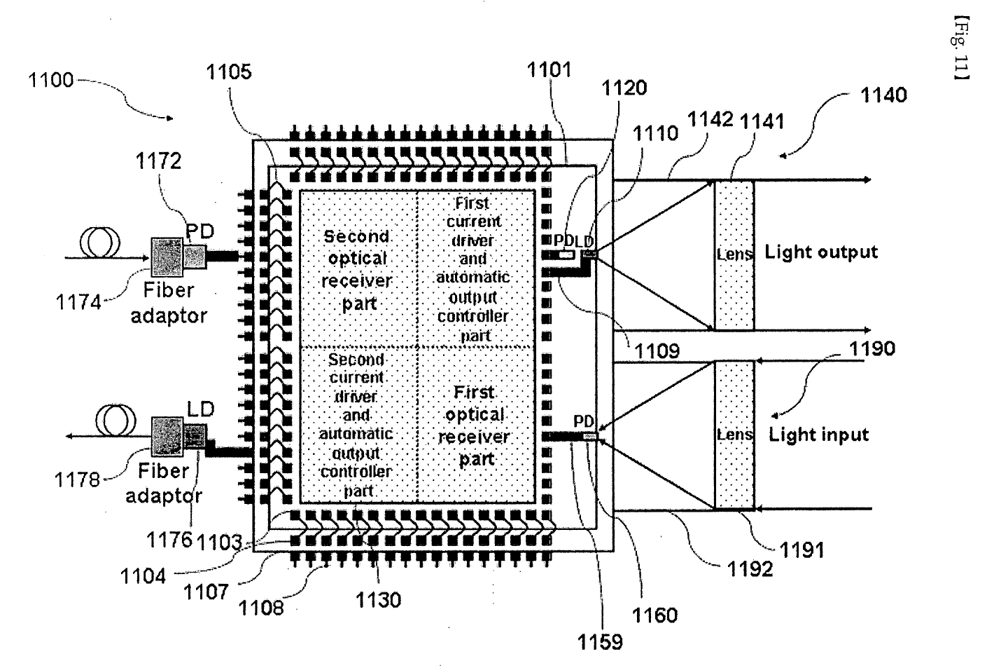

FIG. 11 shows a structure of a transceiver for free space optical communication accessible via an optical fiber link according to an embodiment of the present invention. As shown in FIG. 11, in addition to a first current driver and automatic output controller circuit and a first optical receiver circuit for free space optical communication, a second current driver and automatic output controller circuit and a second optical receiver circuit for optical fiber communication are formed integrally on one semiconductor substrate 1101. An LD 1110 and a PD 1120 connected to the first current driver and automatic output controller circuit and a PD 1160 connected to the first optical receiver circuit are also formed on the substrate 1101. The substrate 1101 is fixed on an IC frame 1107 and wire bonded 1105. A transmitting optics module 1140 and a receiving optics module 1190 are assembled to the free space optical communication side of the IC frame 1107, and a PD 1172 for the second optical receiver circuit and an LD 1176 for the second current driver and automatic output controller circuit are connected to optical fiber communication side to receive the signal transmitted from the optical fiber link and transfer to the first current driver and automatic output controller circuit and to transfer the signal transmitted from the first optical receiver circuit to the optical fiber link, respectively. For this purpose, the PD 1172 and the LD 1176 are connected to the optical fiber links via optical fiber adapters 1174 and 1178, respectively. At this time, the PD 1172 and the LD 1176 for optical fiber communication can be packages mounted on TO-cans.

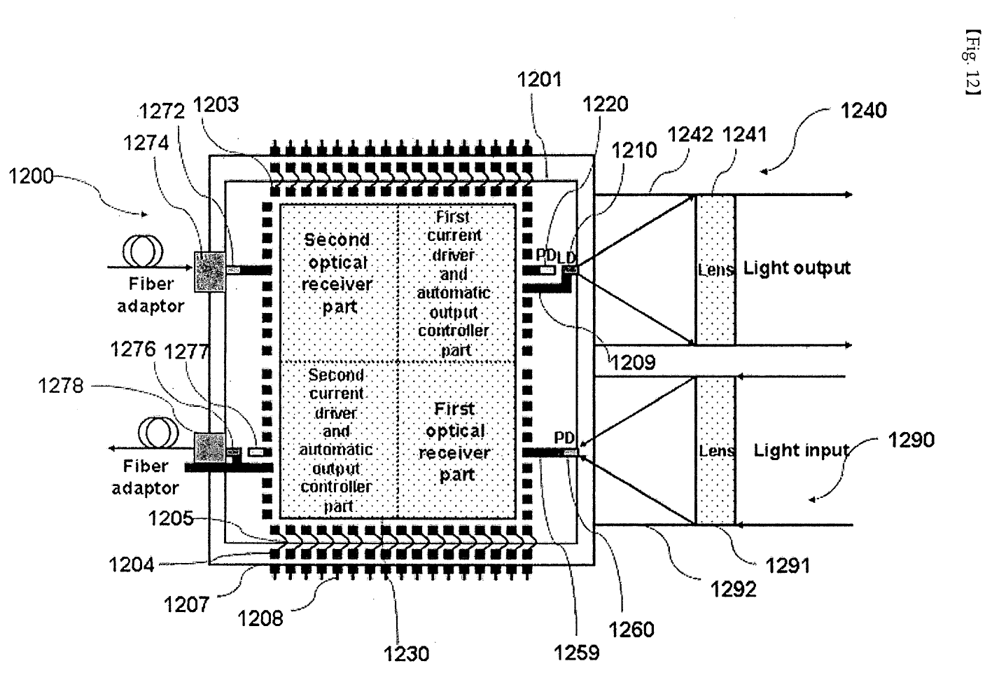

It is possible to form the photo devices such as PD and LD for optical fiber communication together on the semiconductor substrate instead of connecting from the outside of the substrate. FIG. 12 shows a structure of a transceiver in which the photo devices for optical fiber communication are formed on the semiconductor substrate as described above.

As shown in FIG. 12, a light source 1276 and a photo detector 1277 of transmitting part and a photo detector 1272 of receiving part for optical fiber communication are formed on a semiconductor substrate 1201 on which a circuit part 1230 is formed. Next, the light source 1276 and the photo detector 1272 are connected to optical fiber links via optical fiber adapters 1278 and 1274, respectively.

It is possible to form the transmitting and receiving parts of the optical transceivers 1100 and 1200 shown in FIGS. 11 and 12 on separate semiconductor substrates and fix them on PCB substrates to have prescribed intervals as in the transceiver in FIG. 10. That is, after forming the first current driver and automatic output controller circuit and the second optical receiver circuit on one semiconductor substrate and he first optical receiver circuit and the second current driver and automatic output controller circuit on the other semiconductor substrate, each part is fixed on another substrate. As described above, this structure is advantageous when an appropriate interval should be maintained between the transmitting and receiving parts.

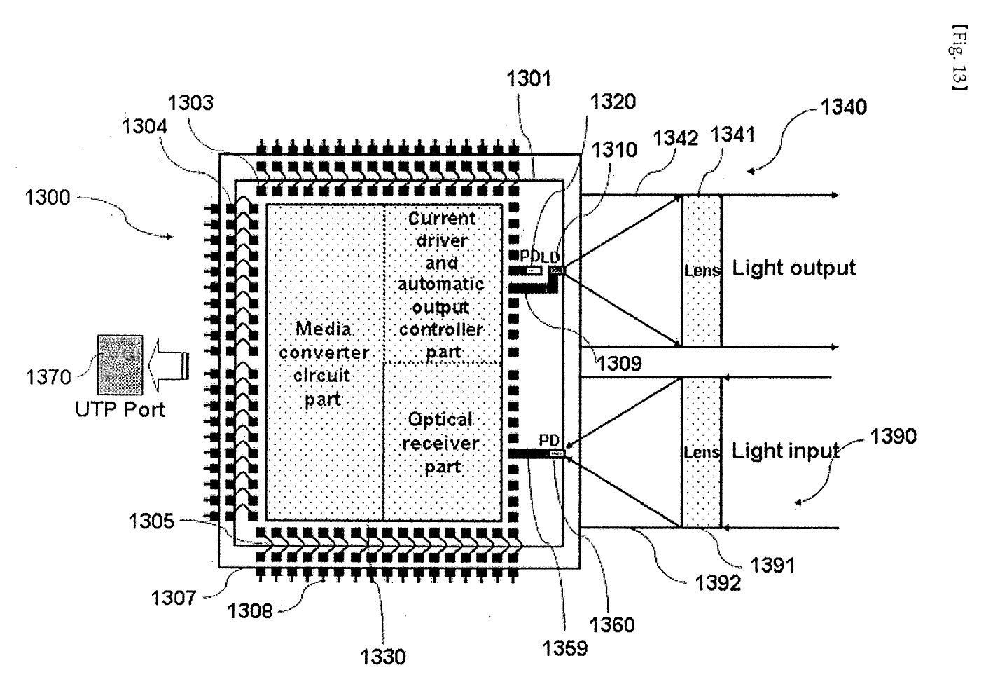

In addition, OWLL and FSON system of the present invention can be effectively used by combining with the existing Ethernet or LAN. For this purpose, Ethernet signals and signals of the optical transceiver of the present invention are transformed to each other using a media converter. The device for this purpose is shown in FIG. 13.

That is, a media converter circuit for data transformation is formed integrally on a semiconductor substrate 1301 together with the current driver and automatic output controller circuit and the optical receiver circuit. The media converter circuit is connected to an unshielded twisted-pair (“UTP”) port 1370 for connection to the Ethernet via a pin 1308 connected to the media converter circuit part of the IC 1330.

However, sometimes the transceiver for OWLL and the media converter should be connected using an optical fiber link because the UTP cable for Ethernet is not able to use for long distance. For example, it is the case that the position of the transceiver for OWLL is far from the position of the subscriber such as a roof of the building. Then, the data signal of the transceiver should be conveyed to the media converter near the subscriber via light. In this case, the optical transceiver having communication function with the optical fiber link described with reference to FIGS. 11 and 12 can be used to connect to the external media converter.

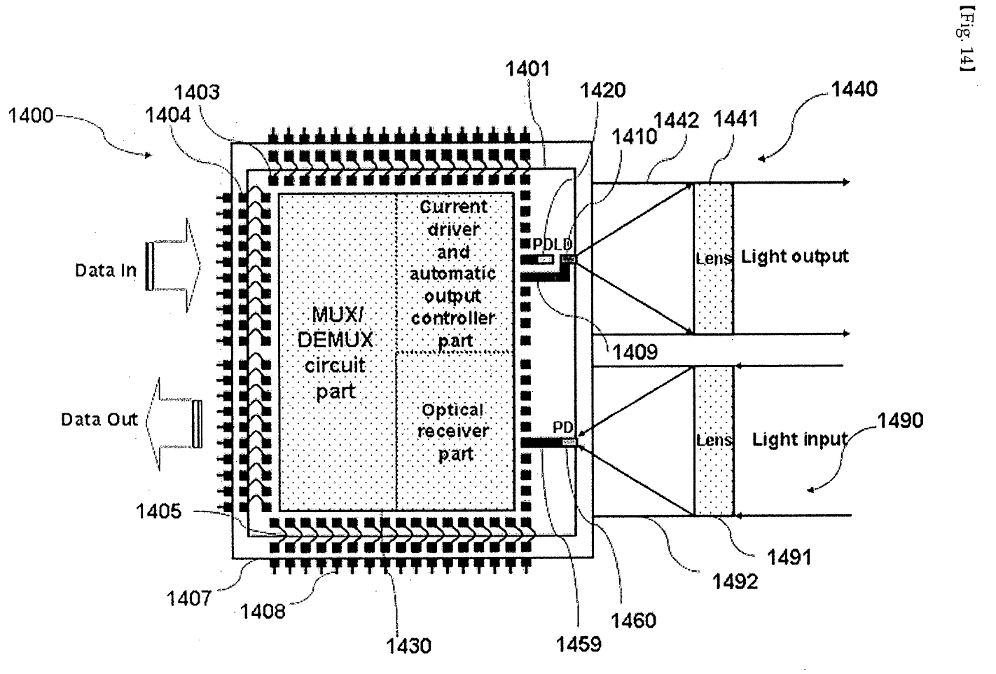

The subscriber network using FSON can be tried in various forms. Both ring type network and star type network using ATM (asynchronous transfer mode) are possible, and tree, bus, and mesh type networks are also possible. When the network is formed, sometimes there is a case that a node uses some data by itself and relays the other data to another node after transmitting/receiving data of large bandwidth from/to the central base station. In this case, a transmitting/receiving module needs a function of multiplexing/demultiplexing. FIG. 14 shows an example of a transponder for OWLL according to the present invention having multiplexing/demultiplexing function.

As shown in FIG. 14, an IC 1430 including a MUX/DEMUX circuit as well as a current driver and automatic output controller circuit of the transmitting side and an optical receiver circuit of the receiving side is formed on a semiconductor substrate 1401 The MUX/DEMUX circuit multiplexes the data transmitted from the input pin, transmits them to the current driver and automatic output controller circuit of the transmitting part, demultiplexes the signals received from the optical receiver circuit, and transmits them to the output pin. An LD 1410 and PDs 1420 and 1460 are formed on the semiconductor substrate 1401, and the other structures are similar to those in the transceiver 1000 shown in FIG. 10.

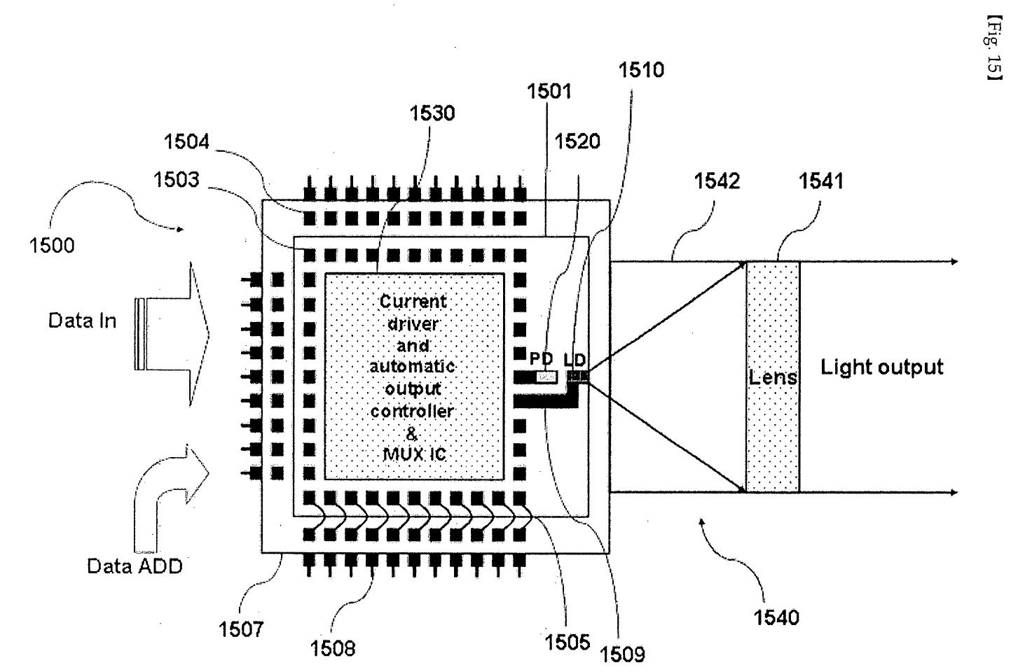

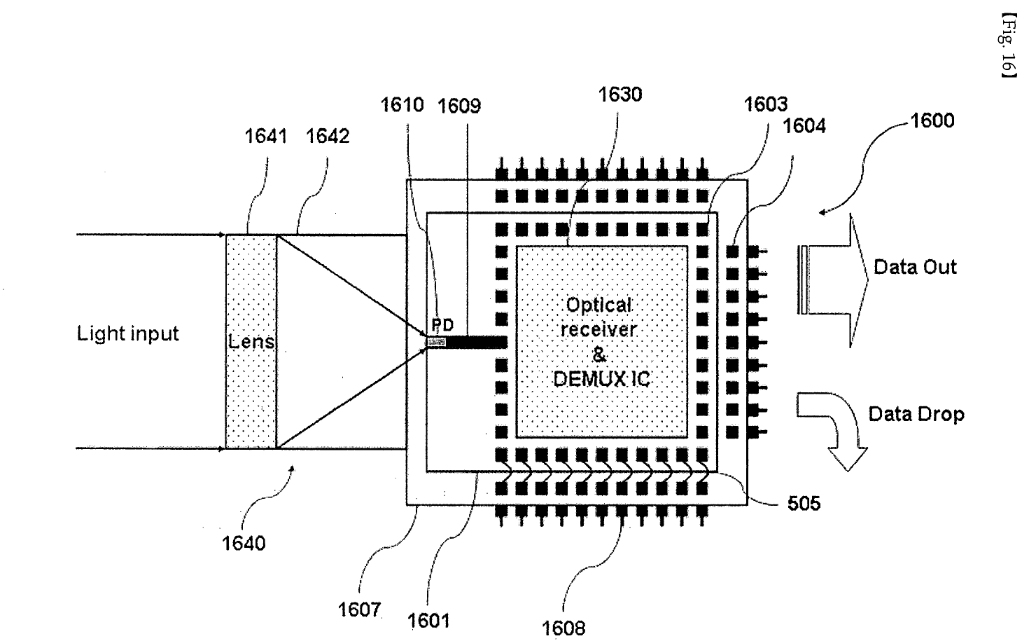

In case that the subscriber network is constituted as a ring network using ATM method, it is necessary to have add/drop function in which signals of some bandwidths among transmitted signals are distributed to the subscriber and signals received from the subscriber are added and transmitted with transmitted signals. FIGS. 15 and 16 show examples of the transponder for FSON having the above-described function. However, in case of FSON system of ring network, directions of transmission and reception are generally different. Therefore, if the transceiver is manufactured as all-in-one type, it may be difficult to use for FSON system. In this regard, the transponder having separate transmitting part and receiving part is formed according to an embodiment of the present invention, and FIGS. 15 and 16 show the structures of the transmitting and receiving parts of the transponder described above.

As shown in FIG. 15, the transmitting part includes an LD 1510, a PD 1520, and an IC 1530 including a current driver and automatic output controller circuit for transmission and a MUX circuit formed on a semiconductor substrate 1501. The IC frame 1507 on which the IC 1530 is fixed is provided with a Data In pin provided with data from the receiving part and a Data ADD pin provided with data to be added on the place where the transceiver is installed. The IC frame 1507 is assembled with the transmitting optics module 1540.

The receiving part is shown in FIG. 16. A PD 1610 and an IC 1630 including an optical receiver circuit for reception and a DEMUX circuit are formed on a semiconductor substrate 1601. An IC frame 1606 on which the IC 1630 is fixed is provided with a Data Out pin providing data to the transmitting part and a Data DROP pin providing data to the place where the transceiver is installed. The IC frame 1607 is assembled with a receiving optics module 1640.

As described above, if the transmitting part and the receiving part are formed as separate modules, it can be easily installed though the directions of transmission and reception are different.

On the other hand, receivers according to embodiments described above have a constitution in which a receiving optics module, photo detector, and optical receiver circuit are arranged serially, but it is possible to place the receiving optics module to be perpendicular with the substrate on which the photo detector and the optical receiver circuit are formed. If so, the substrate may have an additional function of filtering the visible rays, and it is possible to form the lens directly on the semiconductor substrate by etching or coating. Now, those embodiments are described in detail.

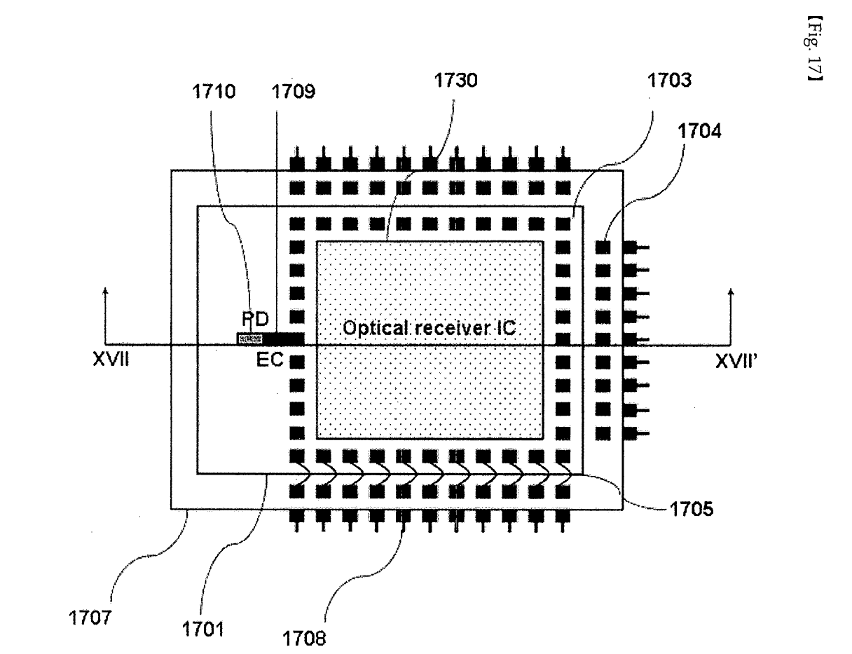

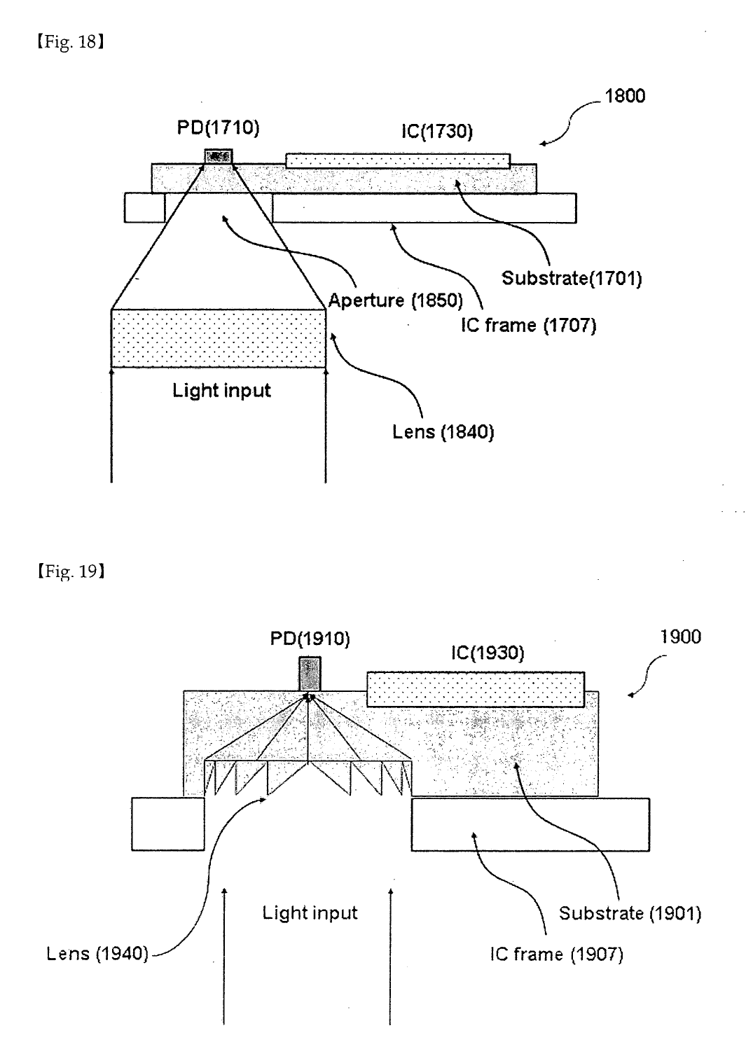

FIG. 17 is a layout diagram showing a structure of a receiver according to another embodiment of the present invention in the direction of the substrate on which a photo detector and an optical receiver circuit are formed, and FIG. 18 is a sectional view of the receiver taken along the line XVIII-XVIII in FIG. 17.

As shown in FIG. 17, an optical receiver IC 1730 and a photo detector 1710 are formed on a semiconductor substrate 1701, and the substrate 1701 is fixed on an IC frame 1707 and wire bonded 1705. The structure of the substrate is similar to the receiver of FIG. 5 described above. On the other hand, in case of the embodiment shown in FIGS. 17 and 18, a lens 1840 of an optics module 1840 is formed in perpendicular direction with the substrate 1701, which can be known from the sectional structure thereof. In addition, the IC frame 1707 have an aperture 1850 to expose a semiconductor area on which the PD 1710 is formed. Then, the light concentrated via the lens 1840 is transferred to the PD 1710 through the substrate 1701 made of Si, etc. Therefore, it is possible to pass a desired light selectively by selecting the substrate material.

Moreover, a lens can be formed directly using a semiconductor substrate without installing a separate lens outside of the substrate. In this case, the manufacturing process of the optical receiver becomes simple, and the size of the receiver becomes smaller.

FIG. 19 shown a sectional view of a receiver in which a lens is formed by etching on the opposite side of the semiconductor substrate on which an optical receiver circuit and a PD are formed according to the present invention. The layout structure of the receiver shown in FIG. 19 is similar to that shown in FIG. 17. A lens 1940 is formed by etching on the opposite surface (lower surface in the drawing) of the substrate 1901 to the surface (upper surface in the drawing) on which an optical receiver circuit 1930 and a PD 1910 are formed. The lens 1940 can be manufactured using etching process of the conventional semiconductor manufacturing process. An aperture to expose the lens 1940 is formed in an IC frame 1907 on which the substrate 1901 is fixed. Since the lens 1940 is formed using the substrate 1901 on which the IC is formed without using separate material, the size of the receiver becomes smaller and the manufacturing process becomes simple.

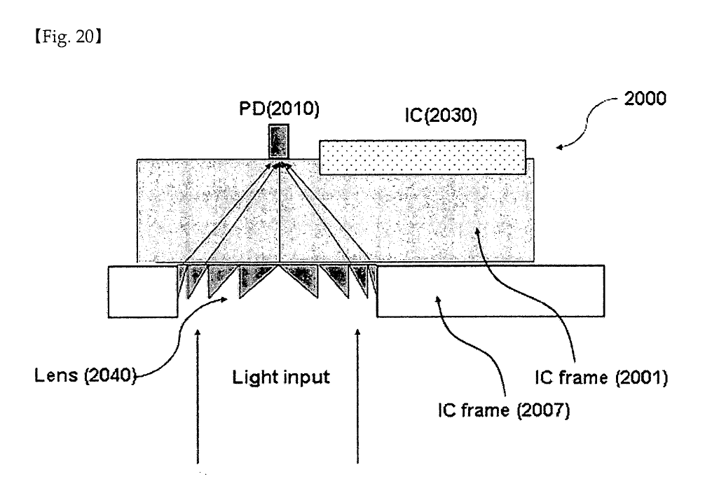

A lens can be formed using coating method. According to an embodiment shown in FIG. 20, a lens 2040 is formed by coating on the opposite surface (lower surface in the dragging) of the substrate 2001 to the surface (upper surface in the drawing) on which a PD 2010 and an IC 2030 are formed. The lens 2040 can be manufactured using coating process of the conventional semiconductor manufacturing process. The layout structure of the receiver is similar to that shown in FIG. 17, and an aperture to expose the lens 2040 is formed in an IC frame 2007 on which the substrate 2001 is fixed.

It is apparent that the characteristics of the receivers described with reference to FIGS. 17 through 20 can be applicable to the receiver and the application apparatuses thereof.

While the present invention has been described in detail with reference to the preferred embodiments, it is to be understood that the invention is not limited to the disclosed embodiments, but, on the contrary, is intended to cover various modifications and equivalent arrangements included within the spirit and scope of the appended claims.

[Industrial Applicability]

The OWLL and FSON system having various advantages comparing to the conventional optical fiber communication system can be established using the transmitter, receiver, and application devices thereof according to the present invention. In addition, the transmitter, receiver, and application devices thereof according to the present invention are small, light, cheap, and standardized. At the same time, the transmitter, receiver, and application devices thereof according to the present invention can provide various functions required in the FSON system, and the provide those functions stably and reliably.

1. A transmitter for Free Space Optical Communication comprising:
a semiconductor substrate;
a light source formed on said substrate;
a photo detector formed on said substrate for detecting the light from said light source;
a current driver and automatic output controller circuit integrally formed on said substrate for driving said light source using the input signals from the outside and controlling the output power of said light source using the signals from said photo detector;
a frame, where said substrate is fixed, having a plurality of pins for electrical connection to the outside; and
an optics module formed to be assembled with said frame for receiving the light from said light source and transmitting the received light to the external free space.

2. The transmitter of claim 1, wherein
said light source is a laser diode or a light emitting diode.

3. The transmitter of claim 1, wherein said optics module comprises:
a lens; and
a lens holder being, able to adjust the focal length of said lens.

4. The transmitter of claim 1, wherein
said lens is an aspheric lens or a Fresnel lens.

5. The transmitter of claim 1, further comprising:
a first screw unit formed to be integrated or assembled with said frame; and
a second screw unit formed to be integrated or assembled with said optics module;
wherein said frame and said optics module are assembled using said first and second screw units.

6. The transmitter of claim 5, wherein
said first and second screw units are standardized whereby various optics modules having lenses of different sizes can be assembled with said frame.

7. The transmitter of claim 1, wherein
the light from said transmitter is eye-safe.

8. A receiver for Free Space Optical Communication comprising:
a semiconductor substrate having a first and a second faces being opposite to each other;
a photo detector formed on said first face of said substrate;
an optical receiver circuit integrally formed on said first face of said substrate for transforming and outputting the signals received from said photo detector;
a frame, where said substrate is fixed, having a plurality of pins for electrical connection to the outside; and
an optics module formed to be assembled with said frame for receiving the light from the external free space and transmitting the received light to said photo detector.

9. The receiver of claim 8, wherein said optical receiver circuit comprises a terminal for monitoring the magnitude of input signal at the outside of said optical receiver circuit.

10. The receiver of claim 9, further comprising:
a display unit connected to said terminal via at least one of said plurality of pins of said frame for displaying said magnitude of input signal to the outside of said receiver.

11. The receiver of claim 9, wherein
said magnitude of input signal can be transferred to the base station at the outside of said receiver.

12. The receiver of claim 8, wherein said optics module comprises:
a lens; and
a lens holder being able to adjust the focal length of said lens.

13. The receiver of claim 12, wherein said lens is an aspheric tens or a Fresnel lens.

14. The receiver of claim 8, further comprising:
a first screw unit formed to be integrated or assembled with said frame; and
a second screw unit formed to be integrated or assembled with said optics module;
wherein said frame and said optics module are assembled using said first and second screw, units.

15. The receiver of claim 14, wherein
said first and second screw unit are standardized whereby various optics modules having lenses of different sizes can be assembled with said frame.

16. The receiver of claim 8, wherein
said optics module is arranged in a row with said optical receiver circuit and said photo detector.

17. The receiver of claim 8, wherein
said optics module is arranged parallel to said second face on or above said second face side; and
said frame has an aperture exposing a part of said second face opposite to the part of said first face where said light source is formed.

18. The receiver of claim 17, wherein
said optics module is a tens formed on said second face of said substrate; and
said aperture exposes a part where said lens is formed.

19. The receiver of claim 18, wherein
said lens is formed by etching said semiconductor substrate.

20. The receiver of claim 18, wherein
said lens is formed by coating.

21. A transceiver for Free Space Optical Communication comprising:
a semiconductor substrate;
a light source formed on said substrate;
a first photo detector formed on said substrate for detecting the light from said light source;
a current driver and automatic output controller circuit integrally formed on said substrate for driving said light source using the input signals from the outside and controlling the output power of said light source using the signals from said first photo detector;
a second photo detector formed on said substrate;
an optical receiver circuit integrally formed on said substrate for transforming and outputting the signals received from said second photo detector;
a frame, where said substrate is fixed, having a plurality of pins for electrical connection to the outside;
a transmitting optics module formed to be assembled with said frame for receiving the light from said light source and transmitting the received light to the external free space; and
a receiving optics module formed to be assembled with said frame for receiving the light from the external free space and transmitting the received light to said second photo detector.

22. The transceiver of claim 21, further comprising:
a first screw unit formed to be integrated or assembled with said frame and adjacent with the part of said substrate where said light source is formed;
a second screw unit formed to be integrated or assembled with said frame and adjacent with the part of said substrate where said second photo detector is formed;
a third screw unit formed to be integrated or assembled with said transmitting optics module; and
a fourth screw unit formed to be integrated or assembled with said receiving optics module;
wherein said frame and said transmitting optics module are assembled using said first and third screw units; and
wherein said frame and said receiving optics module are assembled using said second and fourth screw units.

23. The transceiver of claim 21, wherein
said transmitting optics module and said receiving optics module face to the same side.

24. The transceiver of claim 21, wherein
said transmitting optics module and said receiving optics module have the same configuration.

25. The transceiver of claim 21, wherein
said transmitting optics module and said receiving optics module have different configurations from each other.

26. A transceiver for Free Space Optical Communication comprising:
a first semiconductor substrate;
a light source formed on said first substrate;
a first photo detector formed on said first substrate for detecting the light from said light source;
a current driver and automatic output controller circuit integrally formed on said first substrate for driving said light source using the input signals from the outside and controlling the output power of said light source using the signals from said first photo detector;
a first frame, where said first substrate is fixed, having a plurality of pins for electrical connection to the outside;
a second semiconductor substrate;
a second photo detector formed on said second substrate;
an optical receiver circuit integrally formed on said second substrate for transforming and outputting the signals received from said second photo detector;
a second frame, where said second substrate is fixed, having a plurality of pins for electrical connection to the outside;
a printed circuit board where said first and second frames are fixed at a predetermined interval;
a transmitting optics module formed to be assembled with said printed circuit board for receiving the light from said light source and transmitting the received light to the external free space; and
a receiving optics module formed to be assembled with said printed circuit board for receiving the light from the external free space and transmitting the received light lo said second photo detector.

27. The transceiver of claim 26, further comprising:
a first screw unit formed to be integrated or assembled with said printed circuit board and adjacent with the part of said first substrate where said light source is formed;
a second screw unit formed to be integrated or assembled with said printed circuit board and adjacent with the part of said second substrate where said second photo detector is formed;
a third screw unit formed to be integrated or assembled with said transmitting optics module; and
a fourth screw unit formed to be integrated or assembled with said receiving optics module;
wherein said printed circuit board and said transmitting optics module are assembled using said first and third screw units; and
wherein said printed circuit board and said receiving optics module are assembled using said second and fourth screw units.

28. A transceiver for Free Space Optical Communication comprising:
a semiconductor substrate;
a first light source formed on said substrate;
a first photo detector formed on said substrate for detecting the light from said first light source;
a first current driver and automatic output controller circuit integrally formed on said substrate for driving said first light source using the input signals from the outside and controlling the output power of said first light source using the signals from said first photo detector;
a first optical receiver circuit integrally formed on said substrate and connected to said first current driver and automatic output controller circuit for providing said first current driver and automatic output controller circuit with input signals;
a second photo detector connected to said first optical receiver circuit for providing said first optical receiver circuit with input signal;
a first optical fiber adaptor connected to said second photo detector for connecting said second photo detector to an optical fiber;
a third photo detector formed on said substrate;
a second optical receiver circuit integrally formed on said substrate for transforming and outputting the signals received from said third photo detector;
a second current driver and automatic output controller circuit integrally formed on said substrate for receiving signals from said second optical receiver circuit;
a second light source connected to said second current driver and automatic output controller circuit and driven bar said second current driver and automatic output controller circuit;
a second optical fiber adaptor connected to said second light source for connecting said second tight source to an optical fiber;
a frame, where said substrate is fixed, having a plurality of pins for electrical connection to the outside;
a transmitting optics module formed to be assembled with said frame for receiving the Light from said first light source and transmitting the received light to the external free space; and
a receiving optics module formed to be assembled with said frame for receiving the light from the external free space and transmitting the received light to said third photo detector.

29. The transceiver of claim 28, wherein
said second photo detector and said second light source are packaged in TO-cans respectively.

30. The transceiver of claim 28, wherein
said second photo detector and said second light source are formed on said substrate.

31. A transceiver for Free Space Optical Communication comprising:
a semiconductor substrate;
a light source formed on said substrate;
a first photo detector formed on said substrate for detecting the light from said light source;
a current driver and automatic output controller circuit integrally formed on said substrate for driving said light source using the input signals from the outside and controlling the output power of said light source using the signals from said first photo detector;
a second photo detector formed on said substrate;
an optical receiver circuit integrally formed on said substrate for transforming and outputting the signals received from said second photo detector;
a frame, where said substrate is fixed, having a plurality of pins for electrical connection to the outside;
a transmitting optics module formed to be assembled with said frame for receiving the light from said first light source and transmitting the received light to the external free space;
a receiving optics module formed to be assembled with said frame for receiving the light from the external free space and transmitting the received light to said second photo detector; and
a media converter circuit integrally formed on said substrate and connected to said current driver and automatic output controller circuit and said optical receiver circuit, for transforming the signals transmitted from said optical receiver circuit to Ethernet signals and for transforming Ethernet signals received from the outside to said current driver and automatic output controller circuit and transmitting it, and having UTP (unshielded twisted-pair) port for transmitting and receiving Ethernet signals to and from the outside.

32. A transponder for Free Space Optical Communication comprising:
a semiconductor substrate;
a light source formed on said substrate;
a first photo detector formed on said substrate for detecting the light from said light source;
a current driver and automatic output controller circuit integrally formed on said substrate and connected to said light source for driving said light source using the input signals from the outside and controlling the output power of said light source using the signal from said first photo detector;
a multiplexer circuit integrally formed on said substrate and connected to said current driver and automatic output controller circuit for multiplexing the input signals from the outside and outputting the multiplexed signals to said current driver and automatic output controller circuit;
a second photo detector formed on said substrate;
an optical receiver circuit integrally formed on said substrate for transforming and outputting the signals received from said second photo detector;
a demultiplexer circuit integrally formed on said substrate and connected to said optical receiver circuit for receiving signals from said optical receiver circuit and outputting demultiplexed signals;
a frame, where said substrate is fixed, having a plurality of pins for electrical connection to the outside;
a transmitting optics module formed to be assembled with said frame for receiving the light from said first light source and transmitting the received light to the external free space; and
a receiving optics module formed to be assembled with said frame for receiving the light from the external free space and transmitting the received light to said second Photo detector.

33. A transponder for Free Space Optical Communication comprising:
a first semiconductor substrate;
a first photo detector formed on said first substrate;
an optical receiver circuit integrally formed on said first substrate for transforming and outputting the signals received from said first photo detector;
a demultiplexer circuit, integrally formed on said first substrate, having an input port connected to said optical receiver circuit for receiving signals from said optical receiver circuit, a drop port for distributing a part of demultiplexed signals, and an output port for outputting the rest of said demultiplexed signals;
a first frame, where said first substrate is fixed, having a plurality of pills for electrical connection to the outside;
a second semiconductor substrate;
a light source formed on said second substrate;
a second photo detector formed on said substrate for detecting the light from said light source;
a current driver and automatic output controller circuit integrally formed on said second substrate and connected to said light source for driving said light source using the input signals from the outside and controlling the output power of said light source using the signals received from said second photo detector;
a multiplexer circuit, integrally formed on said second substrate, having an input port for receiving signals from said output port of said demultiplexer, an add port for receiving additional signals from the outside, and an output port for outputting multiplexed signal to said current driver and automatic output controller circuit;
a second frame, where said second substrate is fixed, having a plurality of pins for electrical connection for the outside;
a printed circuit board where said first and second frames are fixed at a predetermined interval;
a transmitting optics module formed to be assembled with said printed circuit board for receiving the light from said first light source and transmitting the received light to the external free space; and
a receiving optics module formed to be assembled with said printed circuit board for receiving the light from the external free space and transmitting the received light to said second photo detector.
